(19) United States
(12) Patent Application Publication
(10) Pub. No.: US 2016/0171636 A1
(43) Pub. Date: Jun. 16, 2016

(54) GROUPING SUPPORT METHOD AND APPARATUS

(71) Applicant: FUJITSU LIMITED, Kawasaki-shi (JP)

(72) Inventors: Hidehiko Mayumi, Kawasaki (JP); Toshio Tanaka, Yokohama (JP); Takeaki Kobayashi, Yokohama (JP); Shigenori SASAKI, Kawasaki (JP)

(73) Assignee: FUJITSU LIMITED, Kawasaki-shi (JP)

(21) Appl. No.: 14/957,776

(22) Filed: Dec. 3, 2015

(30) Foreign Application Priority Data
Dec. 10, 2014 (JP) 2014-249874

(51) Int. Cl. G06Q 50/20; H04L 29/06; G06Q 10/10

(52) U.S. Cl. CPC G06Q 50/20; G06Q 10/101; H04L 65/1069

(57) ABSTRACT

A non-transitory computer-readable recording medium contains a grouping support program for causing a computer to execute a process. The process includes receiving an input of the number of groups. A storage part that stores the discussion times of multiple groups and the facilitators of the groups in past discussions is referred to, and one or more of the groups in the past discussions are specified in accordance with a difference between each of the discussion times and a corresponding one of the averages of the discussion times. One or more facilitators are selected from the facilitator or facilitators of the specified one or more of the groups based on the number of groups. The selected one or more facilitators are output.

### CROSS-REFERENCE TO RELATED APPLICATION

This application is based upon and claims the benefit of priority of the prior Japanese Patent Application No. 2014-249874, filed on Dec. 10, 2014, the entire contents of which are incorporated herein by reference.

### FIELD

A certain aspect of the embodiments discussed herein is related to grouping support methods and apparatuses.

### BACKGROUND

In recent years, demonstration experiments of the next generation of education that use electronic terminals including tablet terminals have been conducted, and this next generation of education is expected to prevail in the future.

As one form of education, it has been known to divide pupils or students into multiple groups and cause each group to hold a discussion. It has been further known to select a facilitator for the group from among the members of the group in a group discussion.

Reference may be made to Japanese Laid-Open Patent Publication No. 2011-76268 for related art.

### SUMMARY

According to an aspect of the invention, a non-transitory computer-readable recording medium contains a grouping support program for causing a computer to execute a process. The process includes receiving an input of a number of groups, referring to a storage part that stores discussion times of a plurality of groups and facilitators of the groups in past discussions, and specifying one or more of the groups in the past discussions in accordance with a difference between each of the discussion times and a corresponding one of averages of the discussion times, selecting one or more facilitators from the facilitator or facilitators of the specified one or more of the groups based on the number of groups, and outputting the selected one or more facilitators.

The object and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is a diagram illustrating a configuration of a grouping support system according to a first embodiment;

FIG. 2 is a diagram illustrating a hardware configuration of a teacher terminal;

FIG. 3 is a diagram illustrating a student database;

FIG. 4 is a diagram illustrating a discussion time database;

FIG. 5 is a diagram illustrating a difference database;

FIG. 6 is a diagram illustrating a functional configuration of a teacher terminal;

FIG. 7 is a flowchart illustrating an operation of a teacher terminal

FIG. 8 is a flowchart illustrating an operation of the teacher terminal;

FIG. 9 is a flowchart illustrating an operation of the teacher terminal;

FIG. 10 is a diagram illustrating grouping by the teacher terminal;

FIG. 11 is a diagram illustrating grouping by the teacher terminal;

FIG. 12 is a diagram illustrating an input screen displayed on the teacher terminal;

FIG. 13 is a diagram illustrating a result display screen displayed on the teacher terminal;

FIG. 14 is a diagram illustrating a result display screen displayed on a student terminal;

FIG. 15 is a flowchart illustrating a process of a database updater; and

FIG. 16 is a diagram illustrating a configuration of a grouping support system according to a second embodiment.

### DESCRIPTION OF EMBODIMENTS

In the case of causing multiple groups to have respective discussions, the discussion time may vary or exceed a set time depending on the manner of grouping or facilitators' competence.

In particular, when the time is limited as in the case of a class period, a prolonged discussion in one group may consume time so that the time for class may be pressed or exceeded, or members of a group whose discussion has finished earlier may hinder the progress of a discussion in another group so as to prevent the other group from having a thorough discussion.

According to an aspect, a grouping support method and apparatus that make it possible to reduce variations in discussion time among multiple groups and to terminate discussions in a set time are provided.

According to an aspect, when multiple groups have respective discussions, it is possible to reduce variations in discussion time among the groups and to terminate the discussions in a set time.

Preferred embodiments of the present invention will be explained with reference to accompanying drawings.

### [a] First Embodiment

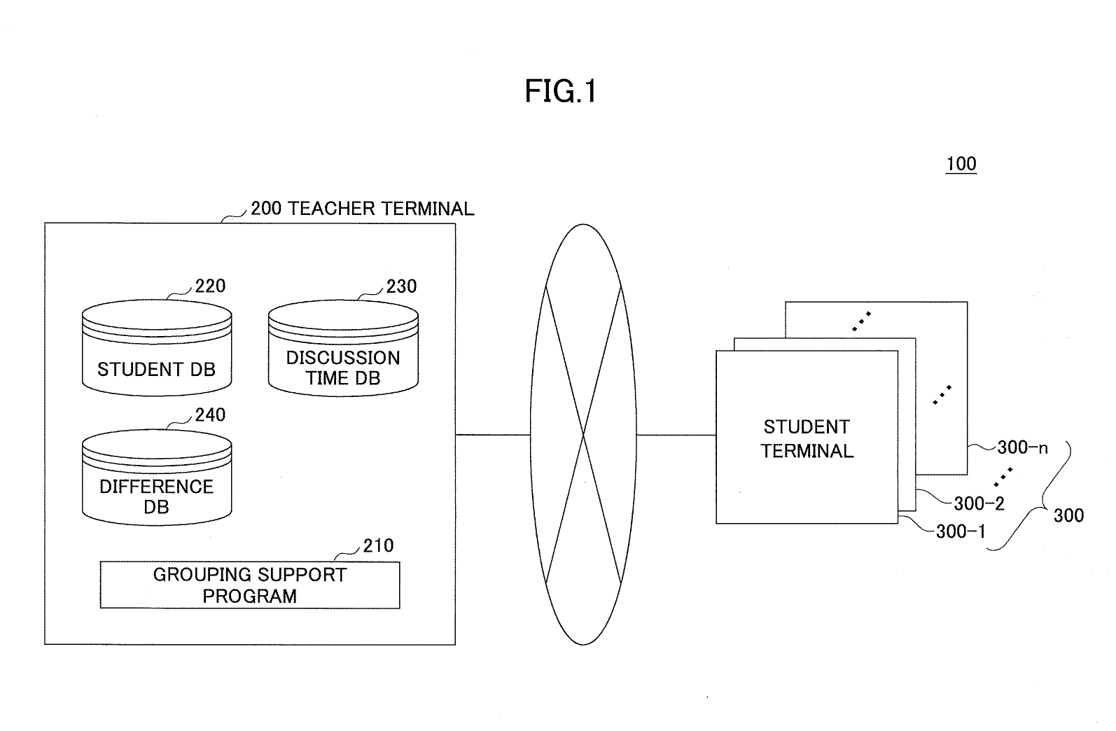

FIG. 1 is a diagram illustrating a configuration of a grouping support system according to a first embodiment.

Referring to FIG. 1, a grouping support system 100 according to this embodiment includes a grouping support apparatus 200 and multiple terminal apparatuses 300-1, 300-2, . . . , 300-n (where n is an integer greater than one). The terminal apparatuses 300-1, 300-2, . . . , 300-n may be collectively referred to as “terminal apparatus 300” or “terminal apparatuses 300” when no distinction is made between them. According to this embodiment, the grouping support apparatus 200 and the terminal apparatuses 300 are connected via a network.

According to this embodiment, the grouping support apparatus 200, which is a terminal apparatus that is basically used by a teacher, is hereinafter referred to as “teacher terminal 200.” On the other hand, the terminal apparatuses 300, which are terminal apparatuses basically used by individual pupils or students who take a class, are hereinafter referred to as “student terminal(s) 300.”

According to this embodiment, the teacher terminal 200 and the student terminal 300 may be both tablet terminals or both desktop or notebook computers. Alternatively, the teacher terminal 200 may be one of a tablet terminal and a desktop or notebook computer, and the student terminal 300 may be the other of the table terminal and the desktop or notebook computer.

According to this embodiment, a grouping support program 210 is installed in the teacher terminal 200, and the teacher terminal 200 includes a student database (DB) 220, a discussion time database (DB) 230, and a difference database (DB) 240.

According to this embodiment, the teacher terminal 200 performs grouping, that is, divides students into multiple groups, referring to the databases 220, 230 and 240, by executing the grouping support program 210. To be more specific, the teacher terminal 200 refers to the databases 220, 230 and 240 and extracts students who satisfy a predetermined condition as candidates for facilitators. Then, the teacher terminal 200 selects as many facilitators as a preset number of groups from among the extracted candidates so as to minimize variations in time taken for discussion. Furthermore, the teacher terminal 200 assigns other students to the selected facilitators as members of the groups.

According to this embodiment, the facilitator is a person who is a group facilitator and in charge of facilitating a discussion.

In the following description, time taken for discussion is referred to as a discussion time. The discussion time indicates the interval of time (period) before a group consensus is reached by a group after the start of a discussion. To be more specific, according to this embodiment, the discussion time may be, for example, the interval of time before a group consensus is transmitted from the student terminal 300 of a student who is the facilitator of the group to the teacher terminal 200 after a topic for discussion is transmitted from the teacher terminal 200 to the student terminals 300 of students belonging to the group.

According to this embodiment, variations in discussion time among groups are reduced by selecting as many facilitators as the number of groups so as to minimize the variations in discussion time. Therefore, according to this embodiment, it is possible to save a teacher the trouble of assigning a facilitator to each group by following the daily growth or change of each student's competence as a facilitator.

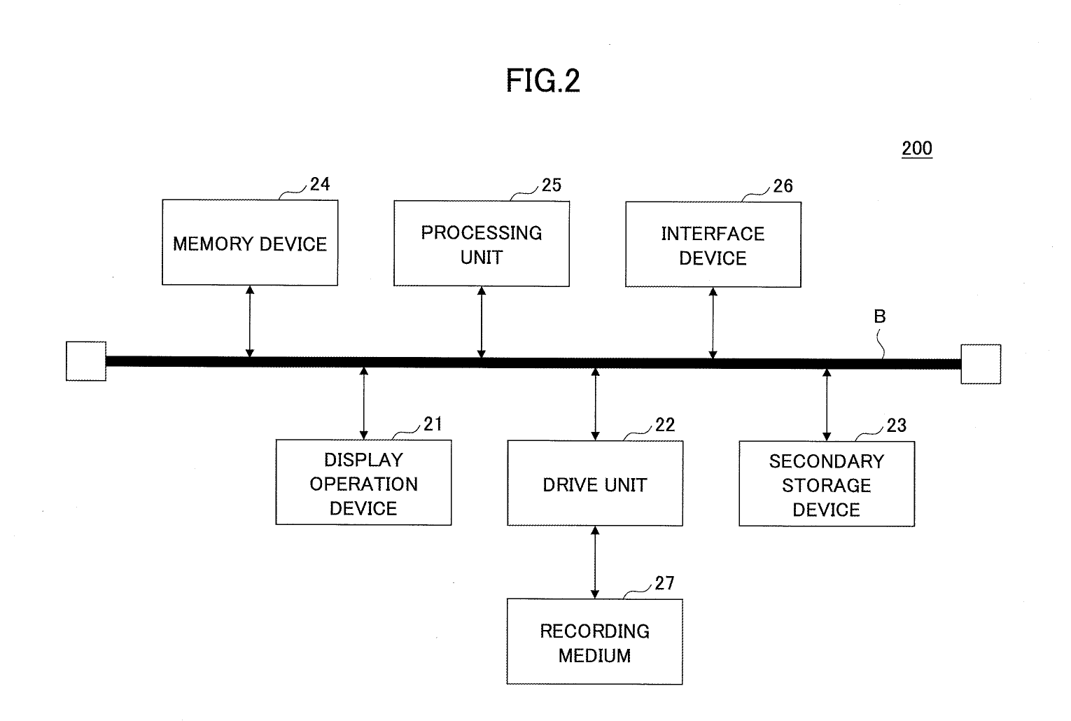

Next, a description is given of the teacher terminal 200 according to this embodiment. FIG. 2 is a diagram illustrating a hardware configuration of a teacher terminal. According to this embodiment, the teacher terminal 200 includes a display operation device 21, a drive unit 22, a secondary storage device 23, a memory device 24, a processing unit 25, and an interface device 26, all of which are interconnected by a bus B.

The display operation device 21, which is a touchscreen panel or the like, is used to input various kinds of signals and display various kinds of information.

The interface device 26, which includes a modem and a LAN card, is used to connect to a network.

The grouping support program 210 is at least part of various kinds of programs that control the teacher terminal 200. The grouping support program 210 is provided by way of, for example, distribution of a recording medium 27 or downloading from a network. Examples of the recording medium 27, on which the grouping support program 210 is recorded, include various types of recording media such as recording media on which information is optically, electrically or magnetically recorded, such as a CD-ROM, a flexible disk, and a magneto-optical disk, and semiconductor memories in which information is electrically recorded, such as a ROM and a flash memory.

Once the recording medium 27 on which the grouping support program 210 is recorded is loaded in the drive unit 22, the grouping support program 210 is installed in the secondary storage device 23 from the recording medium 27 via the drive unit 22. When downloaded from a network, the grouping support program 210 is installed in the secondary storage device 23 via the interface device 26.

The secondary storage device 23 stores the installed grouping support program 210 as well as files and data. The memory device 24 reads the grouping support program 210 from the secondary storage device 23 and stores the read grouping support program 210, when the computer starts. The processing unit 25 implements various kinds of processes as those described below in accordance with the grouping support program 210 stored in the memory device 24.

According to this embodiment, the teacher terminal 200 may be, for example, a desktop or notebook computer. In this case, the teacher terminal 200 includes, in place of the display operation device 21, an input device including a keyboard and a mouse and an output device including a display.

According to this embodiment, the student terminal 300 may have the same hardware configuration as the teacher terminal 200.

Accordingly, a description of the hardware configuration of the student terminal 300 is omitted.

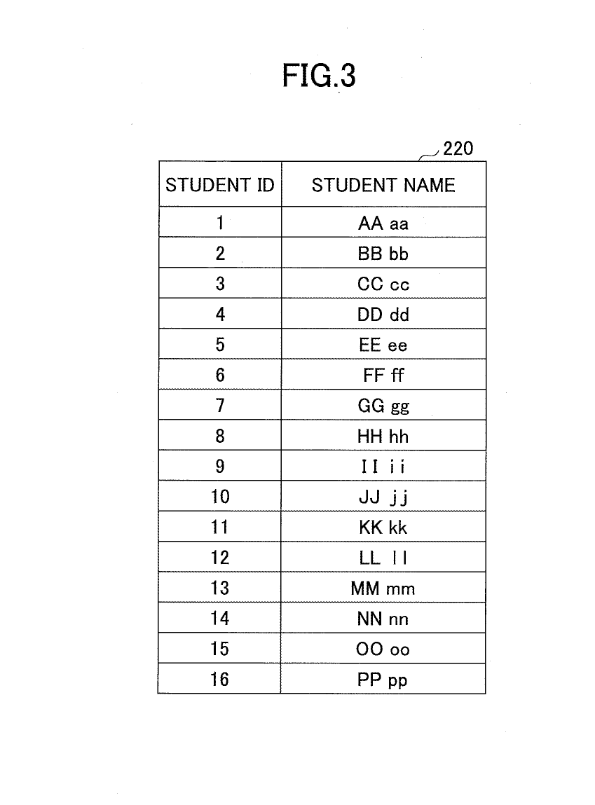

Next, a description is given, with reference to FIGS. 3 through 5, of databases of the teacher terminal 200. The databases are stored in a predetermined area in the secondary storage device 23 or the memory device 24 of the teacher terminal 200.

FIG. 3 is a diagram illustrating a student database. According to this embodiment, the student database 220 has a student ID and a student name as information items, which are correlated with each other. The value of the item “Student ID” is an identifier for identifying a student.

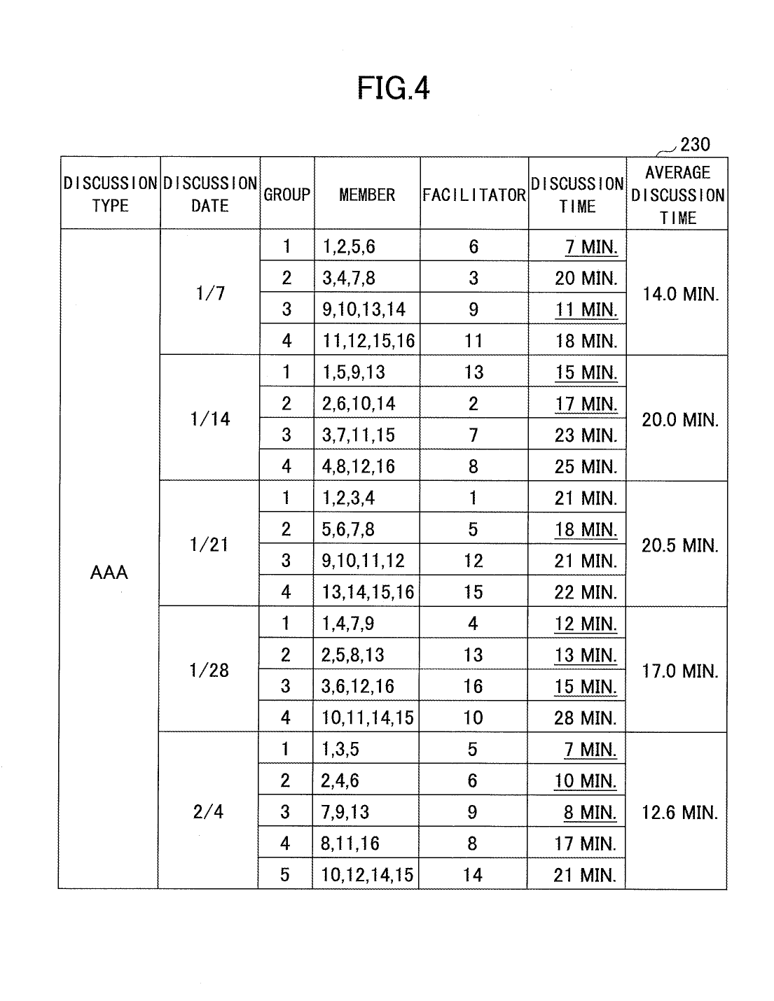

FIG. 4 is a diagram illustrating a discussion time database. According to this embodiment, the discussion time database 230 has a discussion type, a discussion date, a group, a member, a facilitator, a discussion time, and an average discussion time as information items.

The value of the item “Discussion Type” indicates the type of a topic for discussion. The discussion time database 230 illustrated in FIG. 4 stores time pertaining to discussions on the topic of Discussion Type “AAA.” According to this embodiment, the discussion time database 230 is provided, for example, with respect to each discussion type.

The value of the item “Discussion Date” indicates the date of discussion. The value of the item “Group” indicates the identifier of a group after grouping.

The value of the item “Member” indicates the student IDs of students belonging to a corresponding group. The value of the item “Facilitator” indicates the student ID of a student selected as a facilitator for a corresponding group. The value of the item “Discussion Time” indicates time taken for a corresponding group's discussion. The value of the item “Average Discussion Time” indicates the average of the discussion times of the discussions held by the groups at a corresponding date.

In the case of FIG. 4, the discussion time of the discussion held on January 7 by Group “1” whose members are students of Student IDs “1,” “2,” “5,” and “6” with the student of Student ID “6” serving as a facilitator is 7 minutes, and the average discussion time of the discussions held by Groups “1” through “4” on January 7 is 14.0 minutes. Accordingly, it is found that the student of Student ID “6” completed the discussion of Group “1” for which the student served as a facilitator in less than the average discussion time.

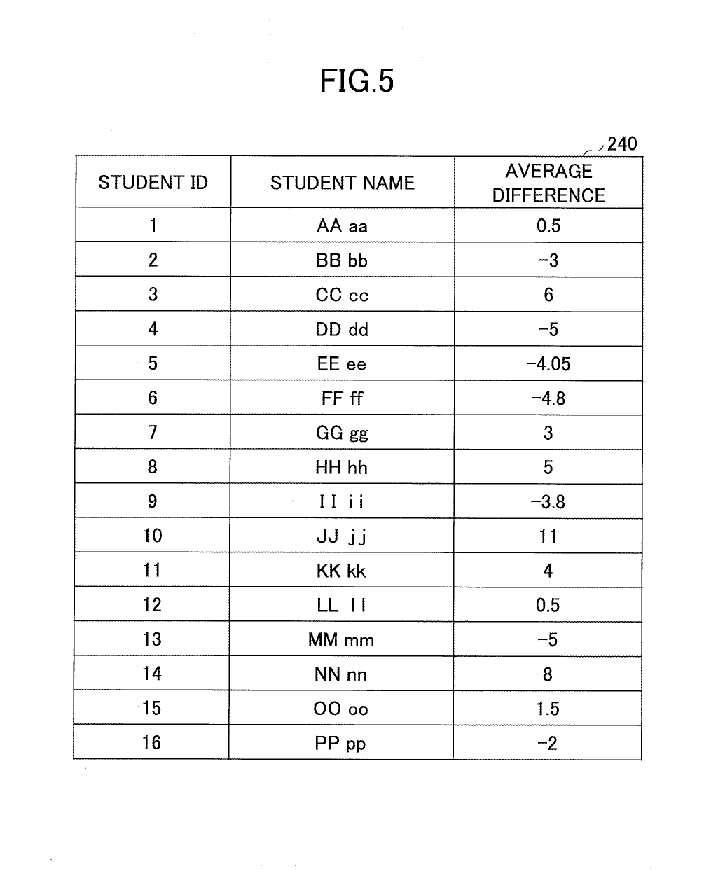

FIG. 5 is a diagram illustrating a difference database. According to this embodiment, the difference database 240 has a student ID, a student name, and an average difference as information items, where the student ID is correlated with the other items.

According to this embodiment, the value of the item “Average Difference” indicates the average of differences between the discussion time of a discussion for which a student of a corresponding student ID serves as a facilitator and the average discussion time. The value of the item “Average Difference” is calculated based on the discussion time database 230.

For example, according to the discussion time database 230, the student of Student ID “6” is selected as a facilitator for Group “1” on January 7 and Group “2” on February 4. The discussion time of Group “1” is 7 minutes and the average discussion time is 14 minutes on January 7. Accordingly, the difference determined by subtracting the average discussion time from the discussion time is −7 minutes.

Likewise, the difference in Group “2” on February 4 is determined as −2.6 minutes by subtracting the average discussion time of 12.6 minutes from the discussion time of 10 minutes. Accordingly, the average of differences of the student of Student ID “6” is determined by {(−7)+(−2.6)}/2 to be −4.8 minutes.

According to this embodiment, the difference database 240 may be generated every time a grouping support processing part 210A to be described below executes a process. Furthermore, according to this embodiment, the difference database 240 may be deleted after completion of grouping by the grouping support processing part 210A.

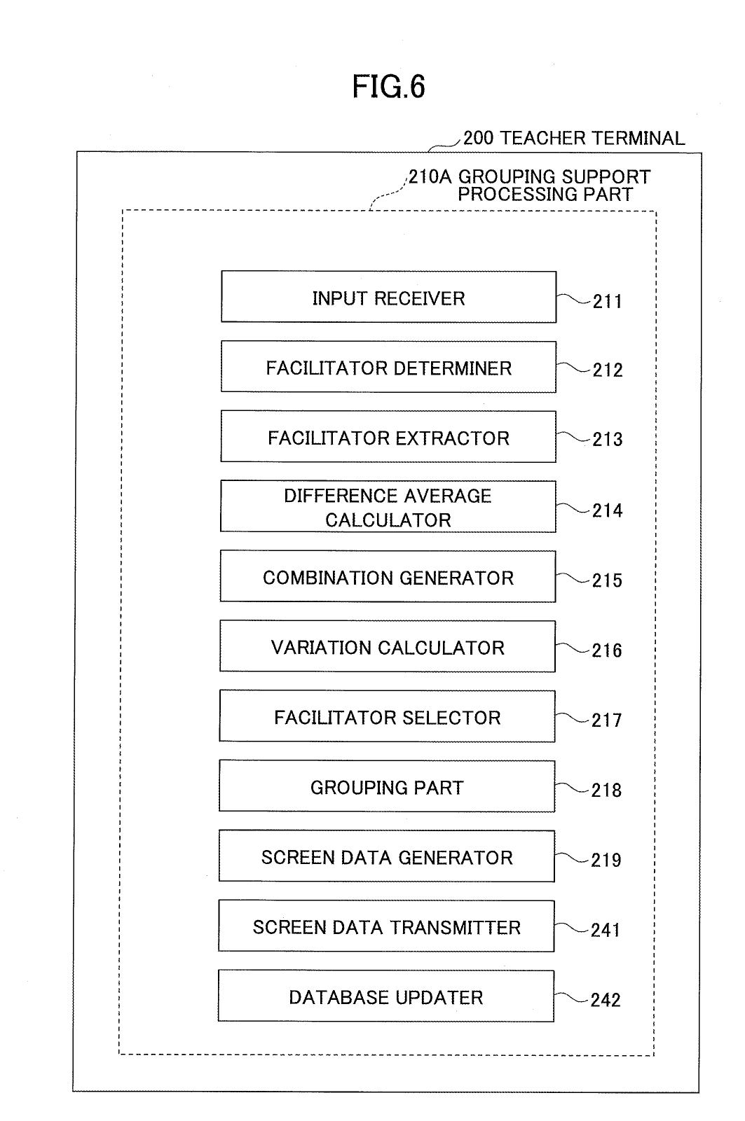

Next, a description is given, with reference to FIG. 6, of functions of the teacher terminal 200 according to this embodiment. FIG. 6 is a diagram illustrating a functional configuration of a teacher terminal.

According to this embodiment, the teacher terminal 200 includes the grouping support processing part 210A. The teacher terminal 200 executes the grouping support program 210 by the processing unit 25, so that the grouping support processing part 210A is implemented.

According to this embodiment, the grouping support processing part 210A includes an input receiver 211, a facilitator determiner 212, a facilitator extractor 213, a difference average calculator 214, a combination generator 215, a variation calculator 216, a facilitator selector 217, a grouping part 218, a screen data generator 219, a screen data transmitter 241, and a database updater 242.

According to this embodiment, the input receiver 211 receives inputs to the teacher terminal 200. For example, the input receiver 211 receives information input on the display operation device 21. Furthermore, the input receiver 211 receives input information transmitted from the student terminal 300.

The facilitator determiner 212 determines whether the information received by the input receiver 211 includes information that specifies a facilitator. For example, the facilitator determiner 212 determines whether the information input on an input screen displayed on the display operation device 21 includes the value of a student ID specified as a facilitator.

The facilitator extractor 213 refers to the discussion time database 230 and extracts the student ID of a student who is a candidate for a facilitator. A student who is a candidate for a facilitator is, for example, a student selected as a facilitator for the group whose discussion time is shorter than both the pre-input scheduled discussion time and the average discussion time.

The scheduled discussion time is time input in advance by a teacher or the like at the teacher terminal 200 before starting discussion. In other words, the scheduled discussion time is a target value for time taken before the end of discussion after its start. For example, in the case where the scheduled discussion time is 10 minutes, each group is required to finish discussion and have a group consensus in 10 minutes.

The difference average calculator 214 calculates an average difference with respect to each of the student IDs of students extracted as candidates for facilitators, and generates the difference database 240.

The combination generator 215 refers to the difference database 240 and generates as many combinations of student IDs to serve as facilitators as a preset number of groups from the extracted student IDs. A detailed description of a process of the combination generator 215 is given below.

The variation calculator 216 calculates a variation in average differences with respect to each of the combinations of student IDs generated by the combination generator 215.

The facilitator selector 217 selects the student IDs included in the combination of the least variation in the values of average difference as facilitators one for each group.

The grouping part 218 groups the student IDs of the students other than the students selected as facilitators into the groups.

The screen data generator 219 generates the screen data of a screen that is displayed on the teacher terminal 200 and the screen data of a screen that is displayed on the student terminal 300. For example, the screen data generator 219 generates the screen data of the input screen that is displayed on the teacher terminal 200 and the screen data of a result display screen on which the result of grouping is displayed, when a process of the grouping support processing part 210A is executed. The result display screen is displayed on both the teacher terminal 200 and the student terminal 300.

The screen data transmitter 241 transmits the screen data of a screen to be displayed on the student terminal 300 to the student terminal 300.

The database updater 242 updates the discussion time database 230 after the completion of discussions.

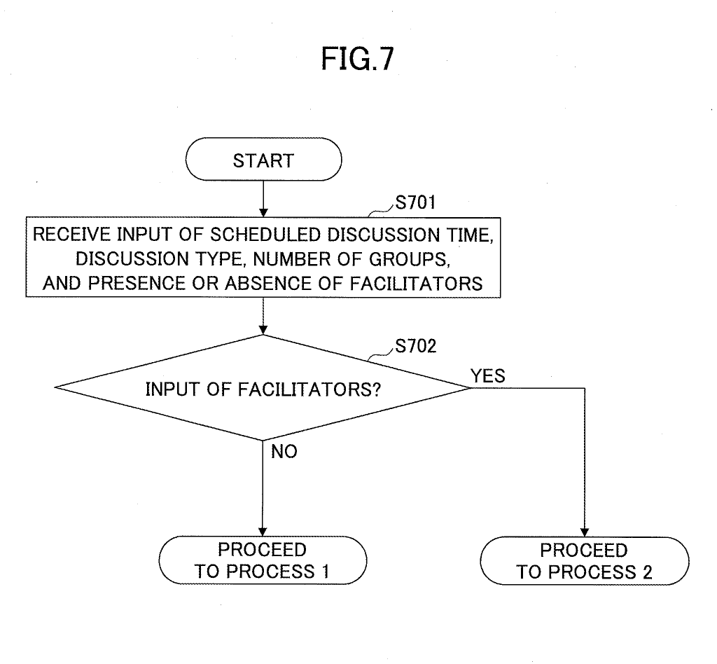

Next, a description is given of operations of the teacher terminal 200 according to this embodiment. FIG. 7 is a flowchart illustrating an operation of a teacher terminal.

At step S701, the teacher terminal 200 receives information input on the input screen, such as a scheduled discussion time, a discussion type, the number of groups, and the presence or absence of facilitators. According to this embodiment, it is assumed that at least a discussion type and the number of groups are input on the input screen displayed on the teacher terminal 200.

Furthermore, according to this embodiment, when no scheduled discussion time is input in the input information, the scheduled discussion time may be calculated in line with the end time of class. In this case, it is assumed that information indicating the end time of class is prestored in the teacher terminal 200. A detailed description of the input screen displayed on the teacher terminal 200 is given below.

Next, at step S702, the teacher terminal 200 determines, by the facilitator determiner 212, whether the received information includes information that specifies one or more facilitators. For example, the facilitator determiner 212 determines whether student IDs are included in the input information. If the input information includes one or more student IDs (YES at step S702), the facilitator determiner 212 determines that one or more facilitators are specified by a teacher. If the input information includes no student ID (NO at step S702), the facilitator determiner 212 determines that no facilitator is specified by a teacher.

If it is determined at step S702 that no facilitator is specified, the teacher terminal 200 proceeds to Process 1 to be described below. If it is determined at step S702 that one or more facilitators are specified, the teacher terminal 200 proceeds to Process 2 to be described below.

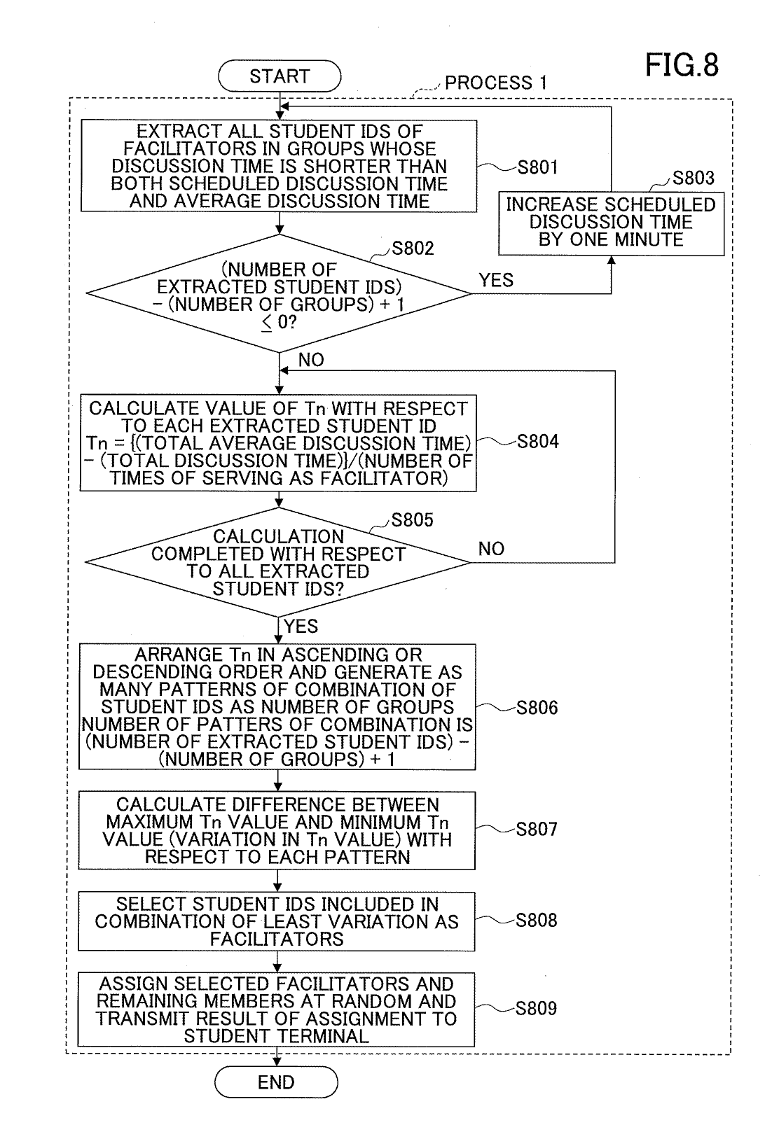

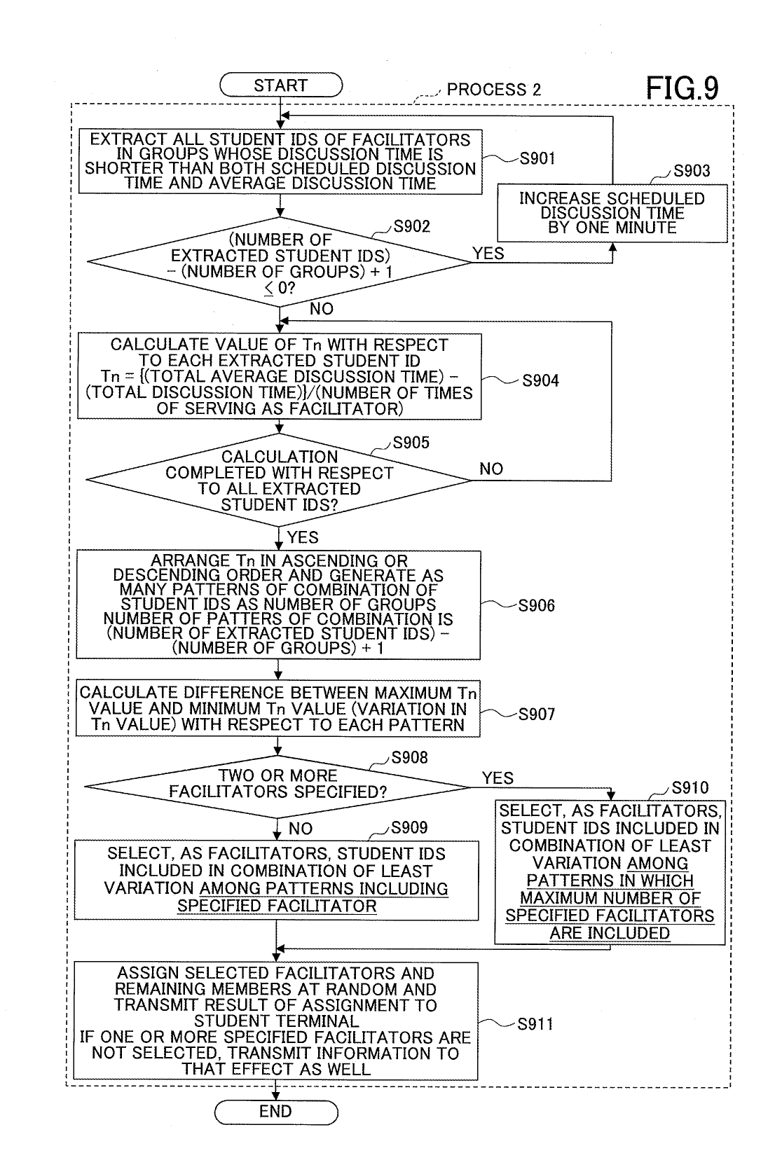

A description is given below, with reference to FIGS. 8 and 9, of Process 1 and Process 2. FIG. 8, which is another flowchart illustrating an operation of a teacher terminal, illustrates Process 1. Process 1 is a process in the case where the input information includes no student ID, that is, in the case where no particular facilitator is specified by a teacher.

At step S801, the teacher terminal 200 refers to the discussion time database 230 and extracts all the student IDs of students selected as facilitators in groups whose discussion time is shorter than both the scheduled discussion time and the average discussion time by the facilitator extractor 213.

Next, at step S802, the teacher terminal 200 determines, by the facilitator extractor 213, whether the number of the extracted student IDs is less than the input number of groups. If it is determined at step S802 that the number of the extracted student IDs is less than the input number of groups (YES at step S802), at step S803, the facilitator extractor 213 increases the scheduled discussion time by one minute, and the teacher terminal 200 returns to step S801.

If it is determined at step S802 that the number of the extracted student IDs is more than or equal to the input number of groups (NO at step S802), at step S804, the teacher terminal 200 calculates an average difference Tn with respect to each extracted student ID by the difference average calculator 214. The average difference Tn is determined by Eq. (1) as follows:

Average difference Tn={(Total average discussion time)−(Total discussion time)}/Number of times of serving as a facilitator. (1)

Next, at step S805, the teacher terminal 200 determines, by the difference average calculator 214, whether the average difference is calculated with respect to all of the extracted student IDs. If it is determined at step S805 that the average difference is not calculated with respect to all of the extracted student IDs (NO at step S805), the teacher terminal 200 returns to step S804.

If it is determined at step S805 that the average difference is calculated with respect to all of the extracted student IDs (YES at step S805), at step S806, the teacher terminal 200 arranges the average differences Tn in ascending or descending order and generates patterns of combination of as many student IDs as the number of groups by the combination generator 215. A detailed description of the patterns of combination at step S806 is given below. The number of the patterns of combination generated at step S806 is given by (the number of extracted student IDs−the number of groups+1).

Next, at step S807, the teacher terminal 200 calculates a variation in the average differences Tn with respect to each pattern of combination. According to this embodiment, a variation in the average differences Tn is the difference between a minimum average difference Tn and a maximum average difference Tn in the combination.

Next, at step S808, the teacher terminal 200 selects the student IDs included in a combination of the least variation as facilitators for the groups by the facilitator selector 217.

Next, at step S809, the teacher terminal 200 groups the student IDs of the students other than the students selected as facilitators at random in line with the number of groups by the grouping part 218, and generates the screen data of a result display screen for displaying the result of grouping by the screen data generator 219. According to this embodiment, the screen data generator 219 may generate both the screen data of a result display screen for the student terminal 300 to be displayed on the student terminal 300 and the screen data of a result display screen for the teacher terminal 200 to be displayed on the teacher terminal 200. The teacher terminal 200 displays the result of grouping based on the screen data for the teacher terminal 200. Furthermore, the teacher terminal 200 transmits the screen data for the student terminal 300 to the student terminal 300 by the screen data transmitter 241.

According to this embodiment, the screen data for the student terminal 300 includes, as the result of grouping, at least the identifier of a group to which the student terminal 300 belongs and information indicating whether a student who uses the student terminal 300 is a facilitator. In the following description, information indicating the result of grouping by a process of the grouping support processing part 210A is referred to as “output information.” Accordingly, the screen data transmitted from the teacher terminal 200 to the student terminal 300 include output information.

FIG. 9, which is yet another flowchart illustrating an operation of a teacher terminal, illustrates Process 2. Process 2 is a process in the case where the input information includes one or more student IDs, that is, in the case where one or more particular facilitators are specified by a teacher.

A description of the process of steps S901 through S907 of FIG. 9, which is equal to the process of steps S801 through S807 of FIG. 8, is omitted.

Following step S907, at step S908, the teacher terminal 200 determines, by the facilitator selector 217, whether two or more facilitators are specified. To be more specific, the facilitator selector 217 determines whether the input information received by the input receiver 211 at step S901 includes two or more student IDs specified as facilitators.

If it is determined at step S908 that two or more facilitators are not specified (NO at step S908), at step S909, the teacher terminal 200 selects, as facilitators by the facilitator selector 217, student IDs included in a combination of the least variation in the average differences Tn among the combinations that include the specified facilitator, and proceeds to step S911 to be described below.

If it is determined at step S908 that two or more facilitators are specified (YES at step S908), at step S910, the teacher terminal 200 selects, as facilitators by the facilitator selector 217, student IDs included in a combination of the least variation in the average differences Tn among the combinations in which a maximum number of the selected facilitators are included.

Next, at step S911, the teacher terminal 200 groups the student IDs of the students other than the students selected as facilitators at random in line with the number of groups by the grouping part 218, and generates the screen data of a result display screen for displaying the result by the screen data generator 219. The teacher terminal 200 transmits the screen data for the student terminal 300 to the student terminal 300 by the screen data transmitter 241. At this point, if all the student IDs included in the input information are not selected as facilitators, the screen data generator 219 generates screen data for displaying a message to that effect on the result display screen for the teacher terminal 200.

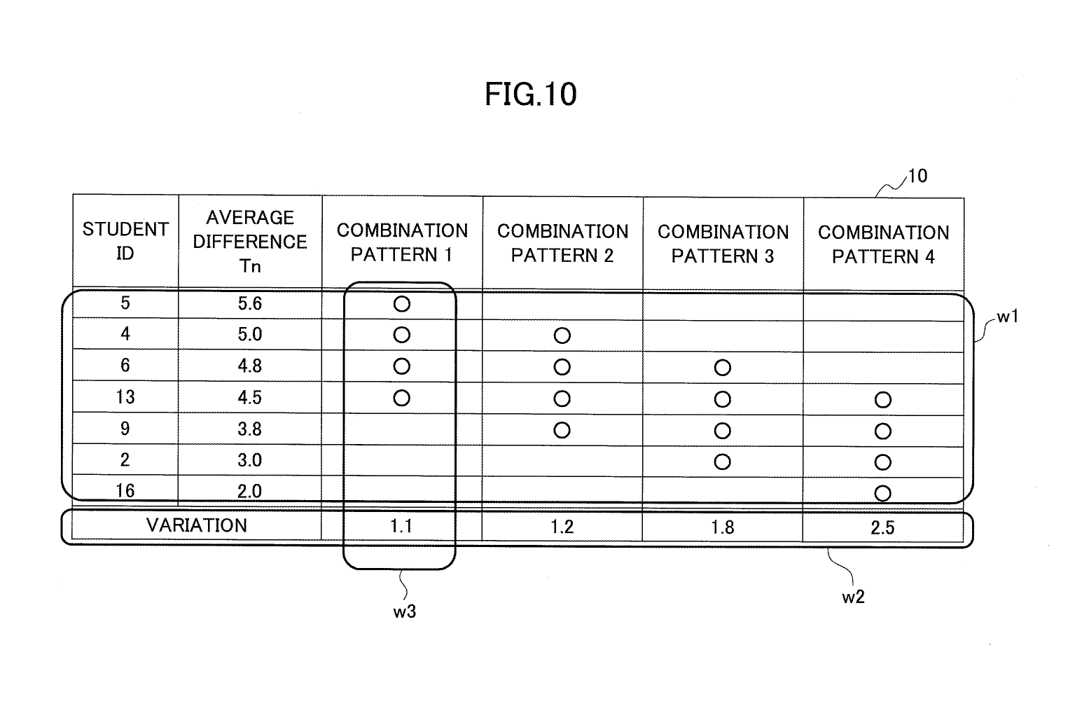

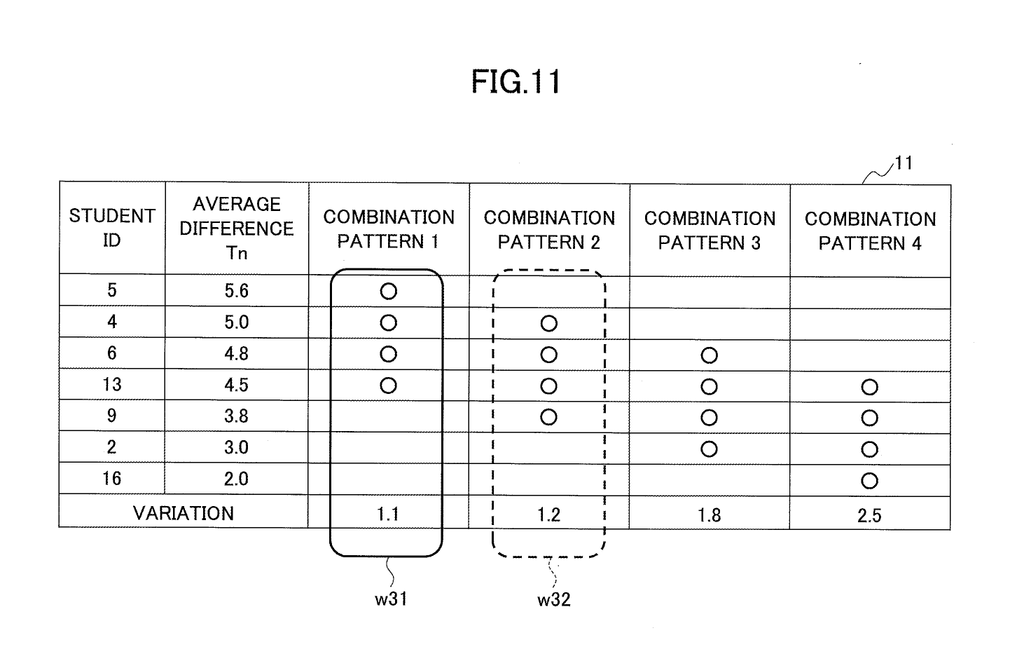

A detailed description is given below, with reference to FIGS. 10 and 11, of a process of the grouping support processing part 210A of the teacher terminal 200 according to this embodiment.

FIG. 10 is a diagram illustrating grouping by a teacher terminal. FIG. 10 illustrates a case where grouping is performed by Process 1 with no facilitator specified by a teacher.

FIG. 10 illustrates an example at the time when the number of groups of “4” and a scheduled discussion time of “17 minutes” are input to the teacher terminal 200 as input information.

The teacher terminal 200 refers to the discussion time database 230 and extracts student IDs serving as facilitators for groups whose discussion time is shorter than 17 minutes and the average discussion time.

In the example of the discussion time database 230 illustrated in FIG. 4, the groups whose discussion time is shorter than 17 minutes are Groups 1 and 3 of January 7, Group 1 of January 4, Groups 1 through 3 of January 28, and Groups 1 through 3 of February 4.

In all of these groups, the discussion time is shorter than the average discussion time.

Accordingly, the facilitator extractor 213 extracts student IDs serving as facilitators in all of these groups.

The facilitator of Group 1 of January 7 is Student ID “6” and the facilitator of Group 3 of January 7 is Student ID “9.” The facilitator of Group 1 of January 14 is Student ID “13.” The student IDs extracted from all of the above-described groups in the above-described manner become the values of the item “Student ID” of a table 10 illustrated in FIG. 10.

Next, the teacher terminal 200 calculates the average difference Tn of each student ID using Eq. (1) by the difference average calculator 214. Next, the teacher terminal 200 arranges the student IDs in descending order of their corresponding average differences Tn by the combination generator 215.

A frame w1 in FIG. 10 indicates a state where the average differences Tn are arranged in descending order, which corresponds to the process of step S806 of FIG. 8.

The combination generator 215 extracts as many student IDs as the number of groups in descending order of the average differences Tn, and determines the extracted student IDs as one pattern of combination. Combination Pattern 1 is composed of four Student IDs “5,” “4,” “6” and “13” extracted in descending order of the average differences Tn from Student ID “5” whose average difference Tn is the largest. Combination Pattern 2 is composed of four Student IDs “4,” “6,” “13” and “9” extracted in descending order of the average differences Tn from Student ID “4” whose average difference Tn is the second largest.

In the above-described manner, the combination generator 215 generates patterns of combination until Student ID “16” whose average difference Tn is the smallest is included in the generated combination pattern. In the example of FIG. 10, four patterns of combination are generated.

Next, the teacher terminal 200 calculates a variation in each pattern by the variation calculator 216.

The variation is the difference between the minimum value and the maximum value of the average differences Tn in one combination. In the case of Combination Pattern 1, the minimum value and the maximum value of the average differences Tn is 4.5 and 5.6, respectively. Accordingly, the variation of Combination Pattern 1 is “1.1.”

In the above-described manner, the variation calculator 216 calculates the variation of each combination pattern. A frame w2 in the table 10 indicates a state where the variations of the combination patterns have been calculated by the variation calculator 216, which corresponds to the process of step S807 of FIG. 8.

Next, the teacher terminal 200 selects the student IDs included in a combination pattern of the least variation as facilitators by the facilitator selector 217. In the example of FIG. 10, Combination Pattern 1 has the least variation. Accordingly, the facilitator selector 217 selects Student IDs “5,” “4,” “6” and “13” included in Combination Pattern 1 as facilitators.

A frame w3 in the table 10 indicates a state where a combination pattern to be selected as facilitators has been determined by the facilitator selector 217, which corresponds to the process of step S808 of FIG. 8.

Once selecting students of Student IDs “5,” “4,” “6” and “13” as facilitators, the teacher terminal 200 groups the students other than the four students at random into four groups, and assigns each facilitator one of the groups of students.

As described above, according to this embodiment, the same number of facilitators as an input number of groups are selected so as to minimize a variation in the average differences between the discussion time of discussions facilitated by the facilitators and the average discussion time. Thus, according to this embodiment, it is possible to reduce a variation in time taken for discussion.

FIG. 11 is another diagram illustrating grouping by a teacher terminal. FIG. 11 illustrates cases where grouping is performed by Process 2 with one or more facilitators specified by a teacher. Specifically, FIG. 11 illustrates the case where Student ID “6” is specified as a facilitator and the case where Student IDs “2,” “4” and “9” are specified as facilitators.

A frame w31 in a table 11 of FIG. 11 indicates a pattern of combination that minimizes a variation in average differences when Student ID “6” is specified as a facilitator.

Combination Pattern 1 has the least variation in average differences among the four combination patterns and also includes Student ID “6” that is the specified facilitator.

Accordingly, the teacher terminal 200 selects students of Student IDs “5,” “4,” “6” and “13” included in Combination Pattern 1 as facilitators.

A frame w32 in the table 11 of FIG. 11 indicates a combination pattern that minimizes a variation in average differences when Student IDs “2,” “4” and “9” are specified as facilitators.

None of Combination Patterns 1 through 4 illustrated in FIG. 11 includes all of Student IDs “2,” “4” and “9.” Accordingly, the facilitator selector 217 searches Combination Patterns 1 through 4 for a combination pattern that includes two of Student IDs “2,” “4” and “9.”

Combination Pattern 1 includes Student ID “4” only. Combination Pattern 2 includes Student IDs “4” and “9” and the value of the variation in average differences is “1.2.” Furthermore, Combination Pattern 3 includes Student IDs “2” and “9” and the value of the variation in average differences is “1.8.” Combination Pattern 4 includes Student IDs “2” and “9” and the value of the variation in average differences is “2.5.”

Accordingly, the facilitator selector 217 selects Combination Pattern 2, which includes Student IDs “4” and “9” and has the least variation in average differences, and selects Student IDs “4,” “6,” “13” and “9” as facilitators.

As described above, according to this embodiment, when one or more facilitators are specified in advance, the same number of facilitators as the number of groups are selected so as that the specified facilitators are included and the variation in average differences is minimized. Accordingly, it is possible to include one or more facilitators specified by a teacher and reduce variations in time taken for discussion.

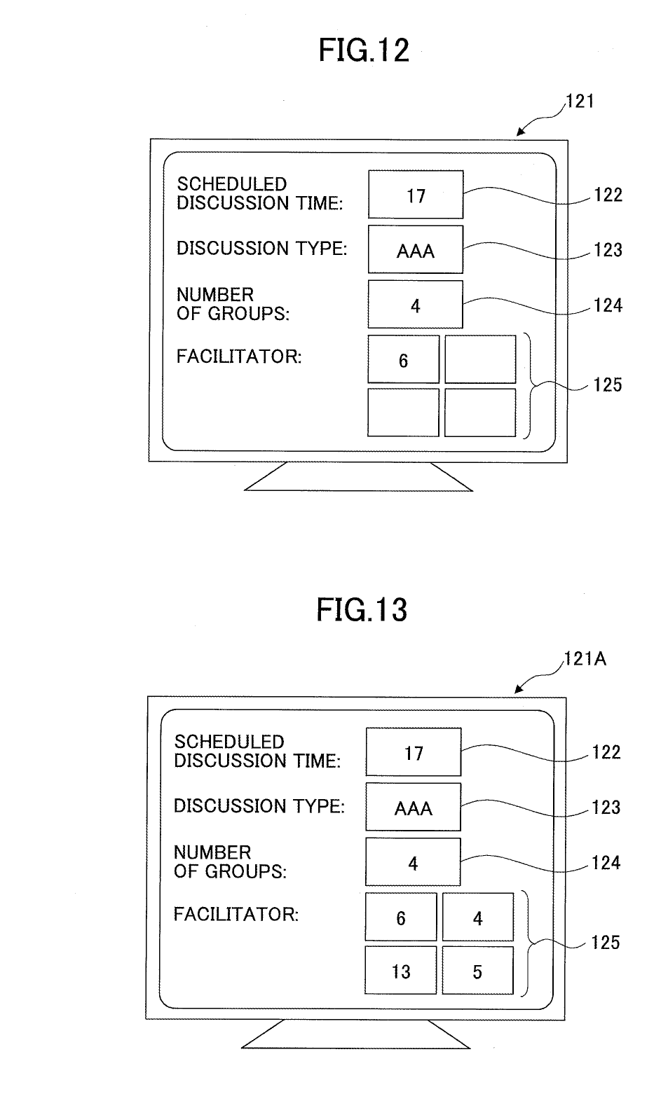

A description is given below, with reference to FIGS. 12 through 14, of screens displayed on the teacher terminal 200 and the student terminal 300.

FIG. 12 is a diagram illustrating an input screen displayed on a teacher terminal. An input screen 121 illustrated in FIG. 12 is displayed on the teacher terminal 200 when the grouping support program 210 is started in the teacher terminal 200, for example.

The input screen 121 includes an input field 122 for inputting a scheduled discussion time, an input field 123 for inputting a discussion type, an input field 124 for inputting the number of groups, and an input field 125 for inputting a student ID to serve as a facilitator.

According to this embodiment, information input to the input fields 122 through 125 included in the input screen 121 become input information. According to this embodiment, a process of the grouping support processing part 210A may be started in response to reception of at least an input of a discussion type to the input field 123 and an input of the number of groups to the input field 124 on the input screen 121.

FIG. 12 illustrates a state of the input screen 121 where a scheduled discussion time of “17 minutes” is input to the input field 122, a discussion type of “AAA” is input to the input field 123, the number of groups of “4” is input to the input field 124, and a student ID of “6” is input to the input field 125.

According to this embodiment, the input field 125 may be displayed so as to include as many input fields for student IDs as the number of groups in response to the inputting of the number of groups to the input field 124, for example. In the example of FIG. 12, the number of groups is four, so that the input field 125 includes four input fields for student IDs.

Furthermore, according to this embodiment, when no scheduled discussion time is input to the input field 122, the teacher terminal 200 may calculate a scheduled discussion time based on a preset class end time and a current time, for example.

FIG. 13 is a diagram illustrating a result display screen displayed on a teacher terminal. A result display screen 121A illustrated in FIG. 13 is displayed on the teacher terminal 200 when grouping by the grouping support processing part 210A ends.

On the result display screen 121A, a result of selection of facilitators is displayed in the input field 125. On the result display screen 121A illustrated in FIG. 13, Student IDs “6,” “4,” “13” and “5” of the facilitators of the selection result are displayed.

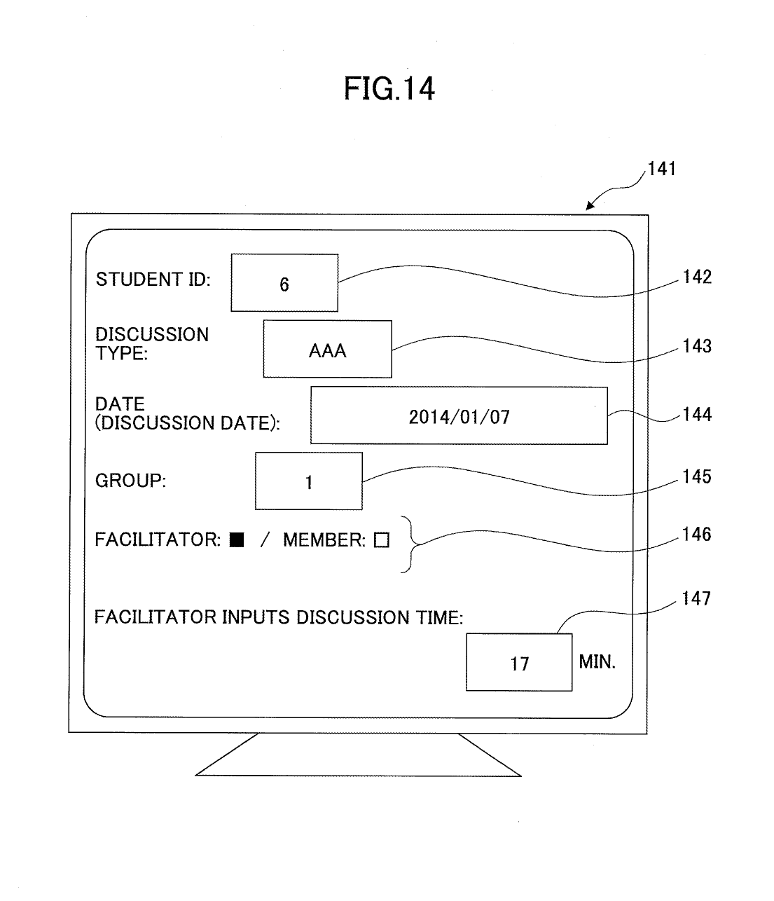

FIG. 14 is a diagram illustrating a result display screen displayed on a student terminal. A result display screen 141 illustrated in FIG. 14, which is displayed on the student terminal 300 when grouping by the grouping support processing part 210A ends, includes output information output by the teacher terminal 200 as the result of grouping.

FIG. 14 illustrates a result display screen 141 displayed on the student terminal 300 of a student selected as a facilitator.

The result display screen 141 includes display fields 142 through 147. The student ID of a student who uses the student terminal 300 is displayed in the display field 142. A discussion type is displayed in the display field 143. A discussion date is displayed in the display field 144. The identifier of a group is displayed in the display field 145. Whether the student is a facilitator is displayed in the display field 146. A scheduled discussion time is displayed in the display field 147. The items displayed in the display field 142 through 147 are output information output by the teacher terminal 200 as a result of grouping.

In the example of FIG. 14, the result display screen 141 is displayed on the student terminal 300 of a student of Student ID “6.” The student terminal 300 may be assigned in advance the student ID of a student who uses the student terminal 300.

Furthermore, it is displayed on the result display screen 141 that the discussion type is “AAA,” the discussion date is January 7, the group identifier is “1,” the student ID is selected as a facilitator, the actual discussion time of the group is 17 minutes.

According to this embodiment, “Member” is selected in the display field 146 on the result display screen 141 of the student terminal 300 of a student who is not selected as a facilitator.

Furthermore, according to this embodiment, a topic for discussion may be displayed on the result display screen 141. Furthermore, according to this embodiment, after the result display screen 141 is displayed, the teacher terminal 200 may transmit information on the topic for discussion to each student terminal 300, so that the topic for discussion is displayed on the student terminal 300. According to this embodiment, a discussion may be started after the student terminal 300 receives the topic.

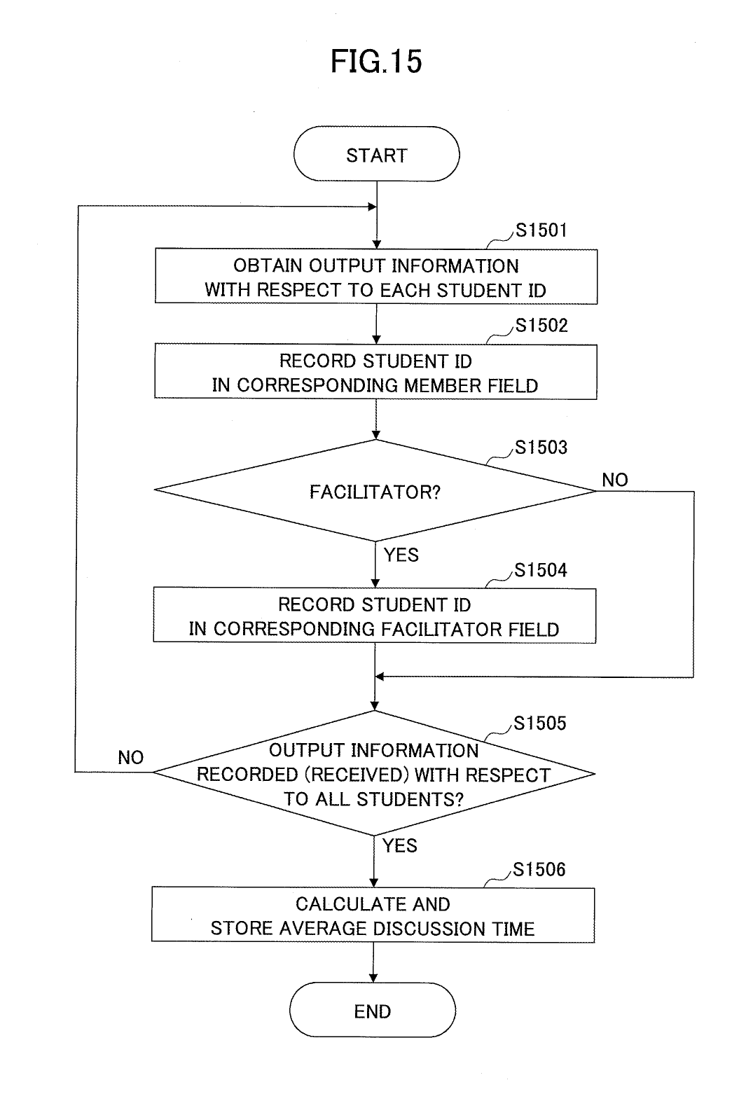

Next, a description is given, with reference to FIG. 15, of a process of updating the discussion time database 230 by the database updater 242 according to this embodiment.

FIG. 15 is a flowchart illustrating a process of a database updater. According to this embodiment, the teacher terminal 200 updates the discussion time database 230 by storing output information that is the result of grouping by the database updater 242.

At step S1501, the teacher terminal 200 obtains output information with respect to each student ID and stores the discussion date of discussions and group identifiers included in the output information in the discussion time database 230 by the database updater 242. The output information of each student ID is included in the screen data transmitted to each student terminal 300 after the completion of grouping.

Furthermore, at this point, the database updater 242 retains the discussion time with respect to each group identifier, and stores the discussion time of each group in correlation with its group identifier as a value of the item “Discussion Time” in the discussion time database 230. The teacher terminal 200 may retain the discussion time by determining the time of reception of a group consensus from the student terminal 300 of a student selected as a facilitator as the end time of discussion.

Next, at step S1502, the teacher terminal 200 stores a student ID in a value of the item “Member” corresponding to the group identifier by the database updater 242.

Next, at step S1503, the database updater 242 determines whether a student is selected as a facilitator. For example, the database updater 242 determines whether the output information includes information indicating that a student ID is selected as a facilitator.

If it is determined at step S1503 that a student ID is selected as a facilitator (YES at step S1503), at step S1504, the database updater 242 stores the student ID in a value of the item “Facilitator” corresponding to the group identifier in the discussion time database 230, and proceeds to step S1505.

If it is determined at step S1503 that a student ID is not selected as a facilitator (NO at step S1503), at step S1505, the database updater 242 determines whether the output information is stored with respect to all student IDs.

If it is determined at step S1505 that the output information is not stored with respect to all student IDs (NO at step S1505), the database updater 242 returns to step S1501.

If it is determined at step S1505 that the output information is stored with respect to all student IDs (YES at step S1505), at step S1506, the database updater 242 calculates an average discussion time with respect to each group, and stores the calculated average discussion time of each group in a value of the item “Average Discussion Time” in correlation with its group identifier, and ends the process.

Thus, according to this embodiment, it is possible to select a facilitator for each group based on the past performance. Therefore, it is possible to reduce variations in discussion time and to make effective use of limited class time.

### [b] Second Embodiment

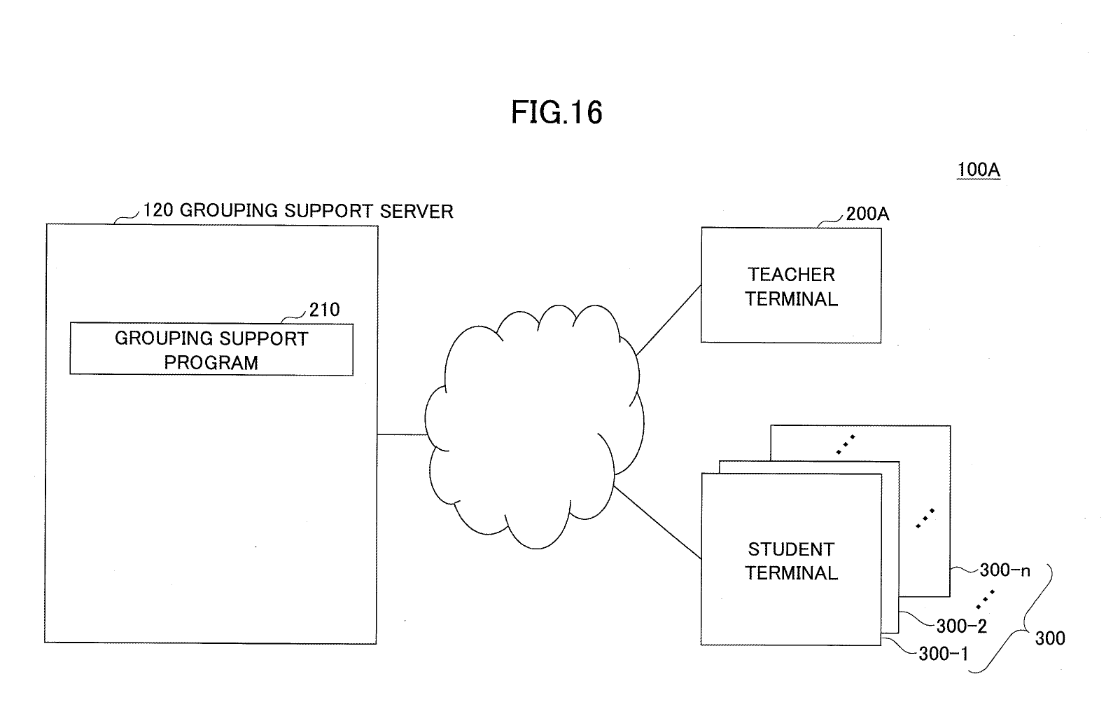

A description is given below, with reference to FIG. 16, of a second embodiment. The second embodiment is different from the first embodiment in that a grouping support server 120 in which a grouping support program is installed is provided in a grouping support system. Accordingly, in the following description of the second embodiment, a description is given of one or more differences from the first embodiment. Elements like those of the first embodiment are referred to by like reference numerals, and their description is omitted.

FIG. 16 is a diagram illustrating a configuration of a grouping support system according to the second embodiment. A grouping support system 100A according to this embodiment includes the grouping support server 120, a teacher terminal 200A, and the student terminal 300. According to this embodiment, the grouping support program 210 is installed in the grouping support server 120. Furthermore, the databases 220, 230 and 240 stored in the teacher terminal 200 of the first embodiment are stored in the grouping support server 120.

According to the grouping support system 100A of this embodiment, a process executed by the teacher terminal 200 of the first embodiment is executed by the grouping support server 120, which transmits the screen data of the above-described various screens to the teacher terminal 200A and the student terminal 300. Thus, according to this embodiment, the teacher terminal 200A may display screen data transmitted from the grouping support server 120.

Furthermore, according to this embodiment, it is assumed that, as a non-limiting example, the databases 220, 230 and 240 are stored in the grouping support server 120. Alternatively, the databases 220, 230 and 240 and tables may be stored in a storage device connectable to the grouping support server 120.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a grouping support program for causing a computer to execute a process, the process comprising:
receiving an input of a number of groups;
referring to a storage part that stores discussion times of a plurality of groups and facilitators of the groups in past discussions, and specifying one or more of the groups in the past discussions in accordance with a difference between each of the discussion times and a corresponding one of averages of the discussion times;
selecting one or more facilitators from the facilitator or facilitators of the specified one or more of the groups based on the number of groups; and
outputting the selected one or more facilitators.

2. The non-transitory computer-readable recording medium as claimed in claim 1, wherein the process further comprises:
performing grouping that assigns one or more students to each of the selected one or more facilitators; and
outputting a result of the grouping.

3. The non-transitory computer-readable recording medium as claimed in claim 2, wherein said outputting the result of the grouping includes
displaying the selected one or more facilitators; and
notifying one or more student terminals of being selected as the one or more facilitators, the one or more student terminals corresponding to the selected one or more facilitators.

4. The non-transitory computer-readable recording medium as claimed in claim 1, wherein said selecting the one or more facilitators includes
extracting one or more facilitators of the specified one or more of the groups having the discussion times each being shorter than a scheduled discussion time and the average of the discussion times in the past discussions;
calculating, with respect to each of the extracted one or more facilitators, an average difference between a total of the averages of the discussion times and a total of the discussion times with respect to the past discussions facilitated by the extracted facilitator;
generating one or more combination patterns each selecting as many student identifiers as the number of groups from the extracted one or more facilitators; and
selecting the one or more facilitators included in one of the one or more combination patterns which one has a least variation in the average differences.

5. The non-transitory computer-readable recording medium as claimed in claim 4, wherein the variation is a difference between a maximum value and a minimum value of the average differences corresponding to the one or more facilitators included in the one of the one or more combination patterns.

6. The non-transitory computer-readable recording medium as claimed in claim 4, wherein when receiving an input of one or more specified facilitators along with the number of groups, said selecting the one or more facilitators selects the one or more facilitators included in the one of the one or more combination patterns which one has the least variation among one or more combination patterns including the one or more specified facilitators.

7. The non-transitory computer-readable recording medium as claimed in claim 6, wherein when a plurality of facilitators is specified in the received input, said selecting the one or more facilitators selects the one or more facilitators included in the one of the one or more combination patterns which one has the least variation among one or more combination patterns including a maximum number of the plurality of specified facilitators.

8. A grouping support method executed by a computer, the grouping support method comprising:
receiving, by the computer, an input of a number of groups;
referring, by the computer, to a storage part that stores discussion times of a plurality of groups and facilitators of the groups in past discussions, and specifying, by the computer, one or more of the groups in the past discussions in accordance with a difference between each of the discussion times and a corresponding one of averages of the discussion times;
selecting, by the computer, one or more facilitators from the facilitator or facilitators of the specified one or more of the groups based on the number of groups; and
outputting, by the computer, the selected one or more facilitators.

9. A grouping support apparatus, comprising:
a processor; and
a memory storing a program that, when executed by the processor, causes the grouping support apparatus to
receive an input of a number of groups;
refer to a storage part that stores discussion times of a plurality of groups and facilitators of the groups in past discussions, and specify one or more of the groups in the past discussions in accordance with a difference between each of the discussion times and a corresponding one of averages of the discussion times;
select one or more facilitators from the facilitator or facilitators of the specified one or more of the groups based on the number of groups; and
output the selected one or more facilitators.
